(19) United States
(12) Patent Application Publication
(10) Pub. No.: US 2002/0128914 A1
(43) Pub. Date: Sep. 12, 2002

(54) Method and system for returning a non-scale-based parcel weight

(75) Inventor: Ronald P. Sansone, Weston, CT (US)

Correspondence Address: Ronald Reichman, Pitney Bowes Inc., 35 Waterview Drive, P.O. Box 3000, Shelton, CT, 06484-8000, US

(73) Assignee: Pitney Bowes Incorporated, World Headquarters, Stamford, CT

(21) Appl. No.: 10/033,224

(22) Filed: Oct. 26, 2001

Related U.S. Application Data
(63) Continuation-in-part of application No. 09/473,542, filed on Dec. 28, 1999, now abandoned.

(51) Int. Cl. G06F 17/00; G01G 19/413

(52) U.S. Cl. 705/23; 705/414

(57) ABSTRACT

The invention is a method and system for determining the weight of an article without the use of a scale. The method begins with the initiation of a rate determining routine in a shipping system application. After initiation, a description of each article to be shipped is entered into a data field of the rate determining routine. A query for a weight associated with each article is then transmitted from the routine to a database. Once the weight has been obtained, it is returned to the routine as an input parameter for use in calculating a rate for shipment of the article to a particular destination. The rate for shipping each of the articles to its particular destination is determined as based upon the input parameters; these may include a destination for the article, a class of service, or a delivery date. The database can be supplemented by comparing data entered into the first data field with data resident in the database; determining whether or not the comparison further determines that the weight is available; and, if the weight is available, then returning the weight to the routine; or if the weight is not available, then querying the routine to determine whether or not a new weight is to be entered into the database by entry through the routine. The new weight can be determined by one of several alternative entry means wherein the new weight is recorded in the entry fields of the database.

This is a continuation-in-part of U.S. patent application Ser. No. 09/473,542 entitled “A Method And System for Returning A Non-Scale-Based Parcel Weight” filed Dec. 28, 1999.

### RELATED APPLICATION

Reference is made to application Ser. No. _______ (Attorney Docket No. E-877), entitled A TRAINABLE DATABASE FOR USE IN A METHOD AND SYSTEM FOR RETURNING A NON-SCALE-BASED WEIGHT, assigned to the assignee of this application and filed on even date herewith.

### FIELD OF THE INVENTION

The present invention relates generally to the field of mail piece and/or parcel weighing and processing in a network; and, more specifically, to the field of determining the weight of an item for mailing or shipping through the use of an applied database in an Internet or intranet data processing environment. The utilization of a trainable database to determine weight is further coupled with the ability of the system to access carrier rating and related functionality so as to provide convenient desktop shipping capability.

### BACKGROUND OF THE INVENTION

The technology afforded by faster and more memory-laden personal computer (PC) based data processing systems has allowed more and more functionality to get to the desktop. Desktop computing, followed by desktop publishing were among the first applications to reap the benefits of increased desktop capabilities. At present, the advances in the development of memory devices, such as hard disk drives, have allowed greater access to routine-intensive software that allows desktop users to produce work product that was being handled by mid-frame computers in the recent past.

The extensive development and advances that have guided the growth of the personal computer and its related systems has run a parallel course over the past decade with the explosive growth of the Internet. Systems that can utilize the Internet effectively provide their users with greater desktop power by accessing data that was previously unavailable or available only through traditional research vehicles. Thus, personal computing power has grown explosively.

As personal computing power has grown, so to has the variety of business related applications that have come to the desktop. Desktop publishing has allowed quality brochures to be produced in-house rather than at a commercial print shop. The Internet has allowed engineers to interactively participate in projects and research, despite the separation of miles; and, activities such as mail piece production and parcel shipping, have found their way to the desktop as well.

Mail piece production, in the business environment, has traditionally been a product of several departments. Accounting produces a billing that is stuffed into envelopes; the envelopes are weighed as they are fed to a postage meter; and, a postage meter prints postage to the individual envelopes as a function of the weight and postal rate tables. This basic sequence is still the way that businesses produce billings on a month-to-month basis. However, the steps between printing of the mail piece contents, stuffing of the envelopes, weighing, and printing of a postage indicia have become quicker, more streamlined, and more accessible.

Parcel shipping, though following a different sequence of steps than mail piece production, also has benefited from desktop production efficiencies. Labels can be printed at the desktop, weighing scales are interconnected to PCs for inputting weight to a parcel shipping application, and manifests for recording the details of parcel pickup and delivery are printed at the desktop as well. Peripherals such as scanners and other input devices can also be added for increased data delivery.

Mailing and shipping applications still rely on an important piece of data in determining the cost of shipment; that piece of data is weight. Programs have been developed that print postage to an envelope at the desktop, but these programs still require a weighing device to input that parameter into an algorithm that will determine the proper postage rate to be applied when producing a postage indicia. An exception to a weight-based need is when the postage is set at a constant value and the weight of the mail piece is estimated; this exception is particularly susceptible to human error because of the estimation involved. Parcel shipping, in particular, is tied to the weight parameter in determining a cost for shipping a parcel because of the profusion of services available from individual carriers and the fact that parcels tend to be of varied weight and size.

Some developed technology has attempted to eliminate the need for utilizing a weighing scale for inputting the weight parameter in determining postage charges. One such method and system has been disclosed in U.S. Pat. No. 5,983,209 for a SYSTEM AND METHOD FOR DETERMINATION OF POSTAL ITEM WEIGHT BY CONTEXT issued Nov. 9, 1999 to Salim G. Kara (hereinafter referred to as Kara). In Kara, parameters are input into the system that are associated with the context in which the mail piece is generated; the parameters can be manually input or can be input by the application which is generating the associated mail piece.

One drawback to Kara is the flexibility of the disclosed system. Kara is specifically drawn to “postal items” and thus does not address the issues associated with carrier management systems that require more varied input in addition to performing rate shopping among multiple carriers. Kara, though providing access to a resident database for determining component weights in calculating postage values does not provide a means of accessing non-resident databases; nor does Kara provide a means for training its resident database so as to provide a greater range of rating variables.

Another example of parameter-based charging for mail piece production is disclosed in U.S. Pat. No. 5,873,073 for a METHOD AND SYSTEM FOR MAIL PIECE PRODUCTION UTILIZING A DATA CENTER AND INTER-RELATED COMMUNICATION NETWORKS issued Feb. 16, 1999 to Bresnan et al. (hereinafter referred to as Bresnan). Bresnan discloses a method for producing finished mail pieces wherein the characteristics of the mail piece are input at a first node and the individual mail pieces are produced at a second or subsequent nodes. A cost is associated with each parameter that defines production of the mail piece and a total cost for the production is calculated.

Bresnan provides for building a final cost, akin to the postal value as determined by Kara, but does not address the issue of bringing the full parcel shipping application to the desktop; rather, Bresnan serves as a means of remote production.

Based on the aforementioned needs in the art, it is an object of the present invention to provide a means of reducing reliance on weighing scales, to the extent of even eliminating their use, for supplying a weight parameter to shipping and parcel manifest applications. It is a further object of the present invention to provide a kiosk capability for shipping that reduces or eliminates the use of a weighing scale for supplying a weight parameter input.

Additionally, it is a further object of the present invention to utilize the quickly expanding capabilities and information resources of the Internet to provide a weight parameter to shipping applications and parcel processing routines. And further, it is an object of the present invention to provide input to a trainable database that will further reduce reliance on input from a weighing scale.

### SUMMARY OF THE INVENTION

According to the invention, the object is achieved and the disadvantages of the prior art are overcome by a method and system for non-scale-based weight for use as an input in a shipping application.

The method provides for weight-based determinations of one or more articles to be shipped and comprises a number of steps. These steps begin with the initiation of a rate determining routine in a shipping system application resident in a processor-based data processing system located at a first at a first node. The initiation of the routine can be via Internet or modem. After initiation, a description of each one of the one or more articles is entered into a first data field of the rate determining routine. A query is then transmitted from the routine to a database located at a second node for a weight associated with each of the one or more articles; and, thus the initiating site can be remote to the database or co-located with it.

The database is for storing a set of one or more weights wherein each of the one or more weights is associated with a particular article. The database itself further comprises a set of Universal Product Code (UPC) data which comprises a Universal Product Code (UPC) database which associates a known article with a set of one or more of the article's characteristics and entry fields for supplementing the data to the UPC database. Additionally, the database contains a set of data comprising a recorded weight associated with a set of one or more articles wherein the recorded weight is entered by a system operator.

Once the weight has been obtained, the weight is returned to the routine for use in calculating a rate for shipping one or more articles to a particular destination. The returned weight is entered into a second data field of the shipping system application as an input parameter; and, the rate for shipping each of the one or more articles to its particular destination is determined as based upon the input parameters. The input parameters may include a destination for the article, a class of service, or a delivery date.

Supplementation of the entry fields of the database comprises the steps of comparing data entered into the first data field with data resident in the database; determining whether or not the comparison further determines that the weight is available; and, if the weight is available, then returning the weight to the routine; or if the weight is not available, then querying the routine to determine whether or not a new weight is to be entered into the database by entry through the routine.

The new weight can be determined by one of several alternative entry means wherein the new weight is recorded in the entry fields of the database. The alternative entry can be made via a keyboard entry where the new weight is entered by a system operator; or, can be made via a data capture device such as a scanner or a weighing scale. Additionally, the new weight can be determined by calculating the new weight based upon a set of criteria to be applied to the database and to the first data field, and wherein the new weight is recorded in the entry fields of the database.

The system of the present disclosure comprises a number of elements; these include a data processing system located at a first node. The data processing system further includes a shipping system application having rate determining means for determining a carrier rate to be charged for the shipping of an article via a carrier. The rate determining means includes a rate determining routine having a rates database and access means for accessing a rate determining function of a particular carrier. The rate determining function is accessible via an Internet entry or simply by calling the function from within the system.

The system additionally includes: data entry means for entering a description of the article to be shipped into a first data field of the shipping system application; transmission means for transmitting a query, for a weight associated with the article, from the shipping system application to a database located at a second node and then returning the weight to the application for use by the rate determining means; and, data entry means for entering the weight into a second data field of the shipping system application as an input parameter. The set of input parameters may include a destination for the article, a class of service, or a delivery date. The system further includes calculating means within the rate determining means for calculating the rate for shipping the article to a particular destination as based upon the set of one or more input parameters.

### BRIEF DESCRIPTION OF THE DRAWINGS

FIG. 1 is a diagram of the system of the present invention showing the flow between each of the high-level components of the system.

FIG. 1B is a diagram of a multi-node system wherein each node queries and receives input from a central data center and in turn each node transmits its manifest or postal data to a carrier for acceptance.

FIG. 1C is a block diagram of data processing node which is co-located with the database and wherein the data processing node interfaces with a carrier server in performing rating routines prior to seeking carrier acceptance.

FIG. 1D is a diagram of a data processing node within the present invention which is part of a carrier processing and acceptance network.

FIG. 2A is a flowchart of the method of the present invention.

FIG. 2B is a continuation of the flowchart of FIG. 2A which lists the steps for returning a weight from the weights database.

FIG. 3 is a drawing of a view screen that will be displayed in the personal computer in user's subsystem 10, user station 170, entry nodes 102, 104, 106, 108, and 100;

FIG. 4 is a flow chart of the process for determining the cost of the other materials used to complete the container; and

FIG. 5 is a flow chart showing how the post or carrier detects weight/rating/errors that are identified during normal article/mail piece acceptance processing.

### DETAILED DESCRIPTION OF THE PREFERRED EMBODIMENTS

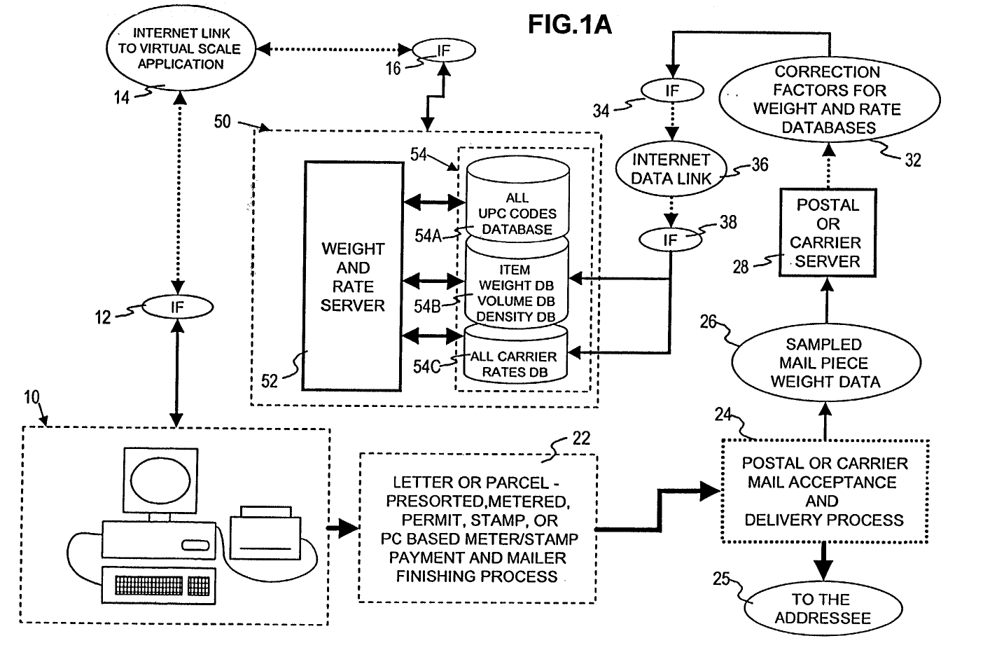

Beginning with FIG. 1A, there is shown a diagram of the system of the present invention showing the flow between each of the high-level components of the system. A system user, who has a parcel or an article to be shipped via a carrier, accesses the overall system through subsystem 10.

Subsystem 10 is shown as a node which includes a personal computer and printer for processing data and running certain software applications, a monitor for providing a human interface with the personal computer so as to view screens established by the application, and a keyboard for data entry. A modem link is implied that will allow access to interface 12. Additional peripherals that are anticipated include a scanner for scanning barcodes and similar data.

Interface 12 links subsystem 10 with the Internet through an Internet link 14. Interface 12 is of a conventional type that includes a web browser and a modem. The Internet link 14 is of a type commercially available through such companies as America-On-Line and is linked to a trainable database 54 through interface 16 which includes a communication link such as a modem.

Database 54 is optionally linked to a weight and rate server 52 to form subsystem 50. Database 54 comprises all universal process codes (UPS) database 54A; item weight, volume and density databases 54B; and all carrier rates database 54C. Subsystem 50 is a remote server which can determine a rate for shipping a parcel in accordance with parameters established in the shipping application hosted by subsystem 10 and a weight returned from database 54. Database 54 can be updated by data entry from subsystem 10 or from periodic and/or random updates transmitted by postal or carrier server 28 and corrected or refined by database correction factors 32.

There are a number of commercially available databases that can serve as input to the trainable database 54, thus reducing training time and expense. Those databases representing portions of the Universal Product Code (UPC) and the European Article Numbering (EAN) systems are the most advantageous because they contain product descriptions and characteristics but not the weight of the item. Currently, portions of these systems are commercially available, while a complete compilation is not available.

The UPC was the first bar code symbology widely adopted and began its commercial life on Apr. 3, 1973, when the grocery industry adopted the UPC as its standard for product marking. Versions of the UPC outside North America began with the adoption of the EAN in December 1976.

The requirements for the UPC symbols are outlined by the American National Standards Institute (ANSI) and are maintained in the United States by ANSI and in Canada by the Electronic Commerce Council of Canada (ECCC). The UPC symbol database, as well as its equivalents outside North America, (i.e., the European Article Numbering system utilizing thirteen (13) digit EAN numbers, the Japanese Article Numbering system utilizing thirteen (13) digit JAN numbers, etc.), are prominent throughout retailing and, in particular, within the grocery industry. The European Article Numbering System (EAN), the Japanese Article Numbering System (JAN), and the International Article Numbering System (IAN) are identical to the UPC except for the number of digits utilized. Currently, the UPC product base contains in excess of 100,000 separate products that are categorized by manufacturer, product type, and shipping container (both standard and unique).

There are two major classifications of UPC code and three minor ones; the two major classifications are the UPC type A code which consists of twelve (12) digits and the UPC type E code which consists of eight (8) digits and is used for those applications where space is limited or restricted. UPC type A symbols have ten (10) digits plus two (2) overhead digits; its EAN counterpart has twelve (12) digits and one (1) overhead digit. The EAN utilizes the first two characters to designate the country of origin of a product. It should be noted that barcode scanning devices equipped to read EAN symbology can read UPC symbols as well; the reverse is not necessarily true however.

The first overhead digit of a UPC type A symbol is a number related to the type of product being described as follows:

0 = normal UPC code
1 = reserved
2 = products sold by weight
3 = health related products
4 = UPC code used without limits
5 = coupons
6 = normal UPC code
7 = normal UPC code
8 = reserved
9 = reserved

In June of 1997, the Uniform Code Council announced that the UPC will be phased out by the year 2005 because the twelve (12) digit UPC will run out of numbers. At that time, the United States will adopt the thirteen (13) digit EAN.

It is not necessary that the UPC and EAN specifications be listed or detailed herein for a proper understanding of the present invention.

Returning to FIG. 1A, subsystem 10 is shown as also linked to the postal or carrier stream through letter or parcel presorted metered permit, stamp, or PC-based meters/stamp payment and mailer finishing process 22 which include the physical mailing of a letter or the shipping of a parcel. The entry of a letter or a parcel into the postal or carrier stream allows the carrier to apply an acceptance and delivery process 24 which produces samples of weight data 26 which are input to carrier server 28. In turn, the carrier server 28 applies the weight database correction factors using the collected weight data so that corrections can be input to the trainable database 54 through interface 34, Internet link 36 and interface 38.

A second embodiment of the present invention is detailed in FIG. 1B, which is a diagram of a multi-node system wherein each node queries and receives input from a centralized data center 100; and, in turn, each node transmits its manifest or postal data to a carrier for acceptance.

Data center 100 is shown as the focal point of a network that includes one or more entry nodes 102, 104, 106, 108, and 110. These nodes are depicted by way of illustration only as it is within the contemplation of this invention that there be one or more entry points into a system that includes data center 100.

Each of the entry nodes 102, 104, 106, 108, and 110 are interoperatively connected to data center 100 by communication links, as well as to the carrier acceptance application 120 which can be remote to the data center 100 or co-located with it. Additionally, a carrier server 130 is provided which administers the database routines for the data center 100 and the carrier acceptance criteria 120. Carrier acceptance criteria 120 allows the carrier to apply an acceptance and delivery process which produces samples of weight data which are input to carrier server 130. In turn, the carrier server 130 applies database correction factors to the collected weight data so that the weight can be input to the trainable database within data center 100. Carrier server 130 can be co-located with either carrier acceptance criteria 120 or data center 100 or both.

A third embodiment of the present invention is shown in FIG. 1C. FIG. 1C is a block diagram of a data processing node which is co-located with the database and wherein the data processing node interfaces with a carrier server is performing rating routines prior to seeking carrier acceptance.

A system user is shown co-located with a data center as element 150. Element 150 may take on one of three embodiments. The first embodiment is a desktop configuration utilizing a PC with at least an operating system, a shipping or carrier management software application, communication links, and a database with related access means for accessing weight data. The second embodiment contemplated is a kiosk wherein the configuration contains the same elements as with the desktop configuration but are housed in a kiosk to provide a retail function wherein the packages are rated and deposited for entry into the carrier traffic stream. The kiosk would be provided with a billing or cash acceptance system so that the cost of shipping could be accounted for at the kiosk. Additionally, a receipt establishing and printing means would give the system user a record of the transaction. The third embodiment is an over-the-counter configuration wherein each of the elements present in the desktop or kiosk configurations are present as well, but the elements are accessed from a counter-top in a retail store environment.

System user and data center 150 is connected to carrier server 152 which provides a rating and services database to the system user via communication links which may be telephone based, Internet based, or line based. Carrier acceptance routine 154 is configured to receive data from the system user, and apply an acceptance routine to determine of the electronic manifest or shipping data received from the system user and data center is acceptable as determined by the carrier's acceptance criteria. The carrier acceptance routine, which may be remote to the carrier server or co-located with it, then transmits the data to the carrier server for tracking or recording which allows the carrier to accept the parcel to be shipped to the addressee 156.

A fourth embodiment of the present invention is shown in FIG. 1D. FIG. 1D is a diagram of a data processing node within the present invention which is part of a carrier processing and acceptance network.

User station 170 serves as a first node for the system and transmits a request for a weight and a corresponding rate to weights database 172. Rates database 172 determines an appropriate weight based upon input at user station 170 and then queries rating database 174 for a rate corresponding to the weight and any services requested by the user station 170. The rate is transmitted by rating database 174 back to the user station 170 through weights database 172, though it is contemplated that the transmission of the appropriate rate could be transmitted by the rating database 174 directly to the user station 170.

User station 170 submits the parcel to be shipped, together with its corresponding rate charge, to the carrier acceptance procedure 178. The carrier acceptance procedure transmits details of the transaction to the carrier server 176 for subsequent parcel tracking, possible billing, and/or statistical analysis. The parcel, upon clearing the carrier acceptance procedure, is then placed into the carriage stream 180 where it is shipped to the addressee.

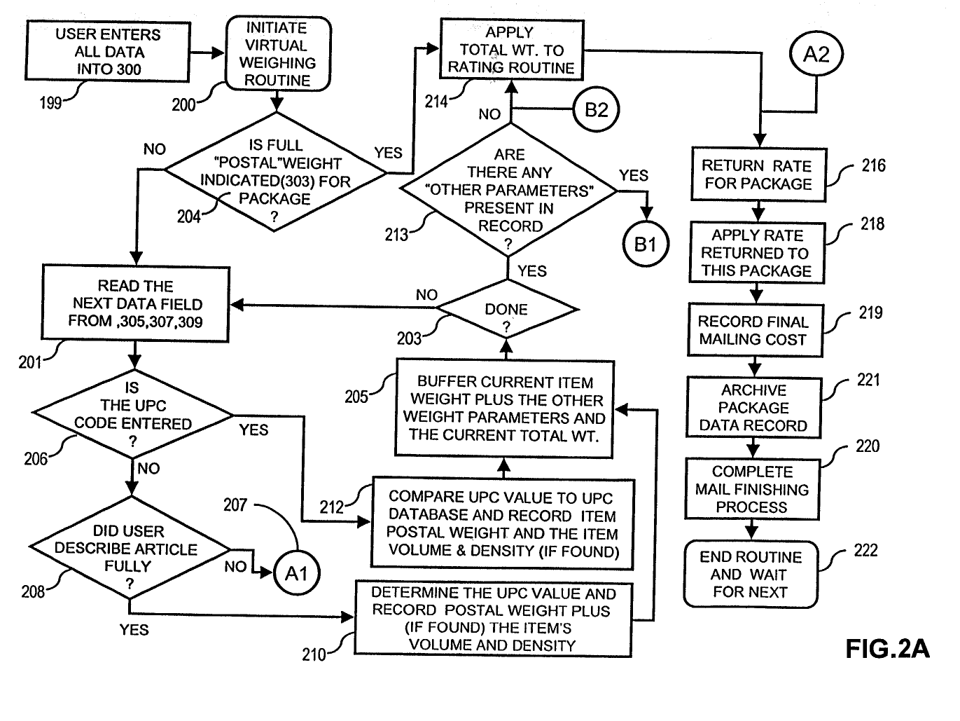

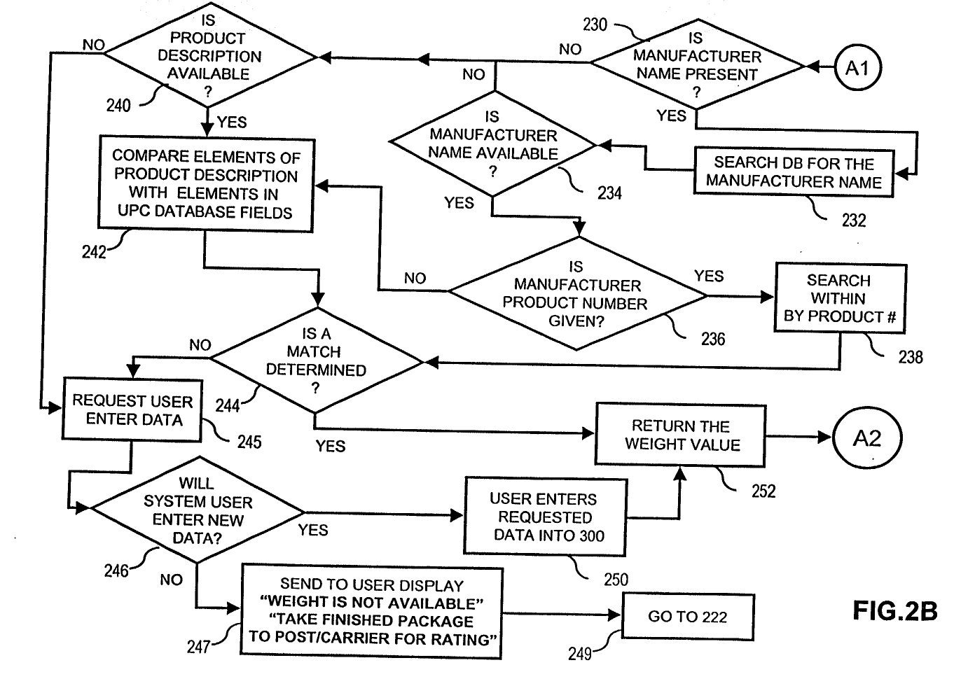

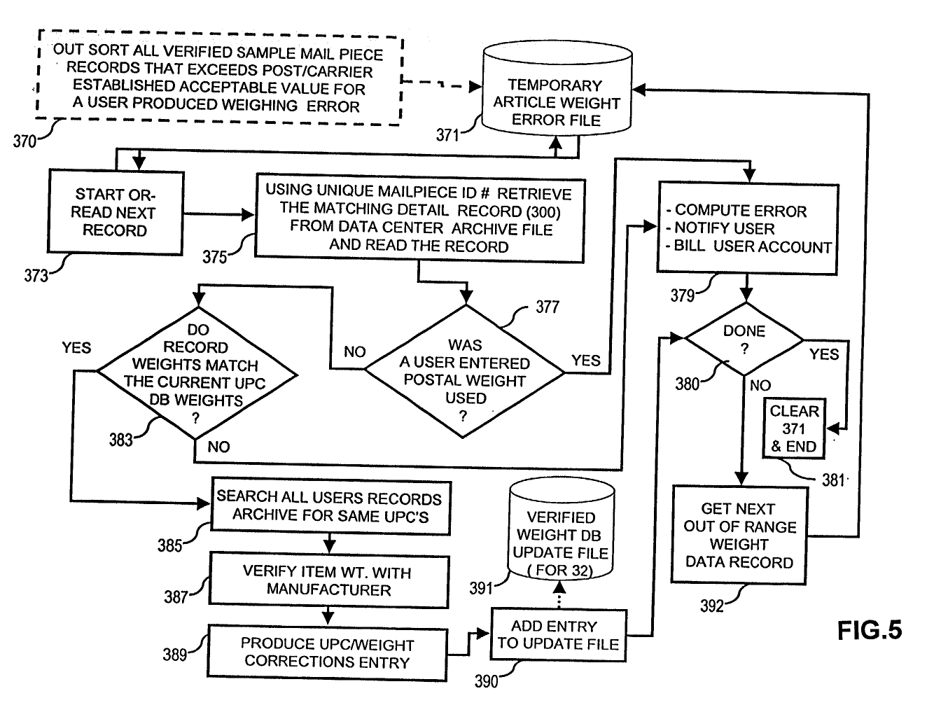

Turning to FIG. 2A, there is shown the method of the preferred embodiment of the present invention. The method begins at step 199 when a user enters data into screen 300 (FIG. 5). Then, in step 200, the initiation of a shipping or carrier management application begins (hereinafter referred to as a shipping application) in a data processing system. The application can be configured to access carrier data representative of one carrier, or in the alternative, can be configured to select from among two or more carriers as based upon selection criteria selected by a system user. For example, such criteria can include: cost; desired date of delivery; available services; or, shipping mode.

From step 200, the method advances to step 204 which asks if a weight has been entered for the article. If the response to the query is “YES,” then the method advances to step 214 where the article data is applied directly to a rating routine for determining the rate to be charged for shipping the article via the selected carrier. The method advances from step 214 to step 216 where the total rate is returned for the container. If, however, the response to step 204 is “NO,” then the method advances to step 201 to read the next data field from data fields 305, 307 and 309. Then the program goes to step 206.

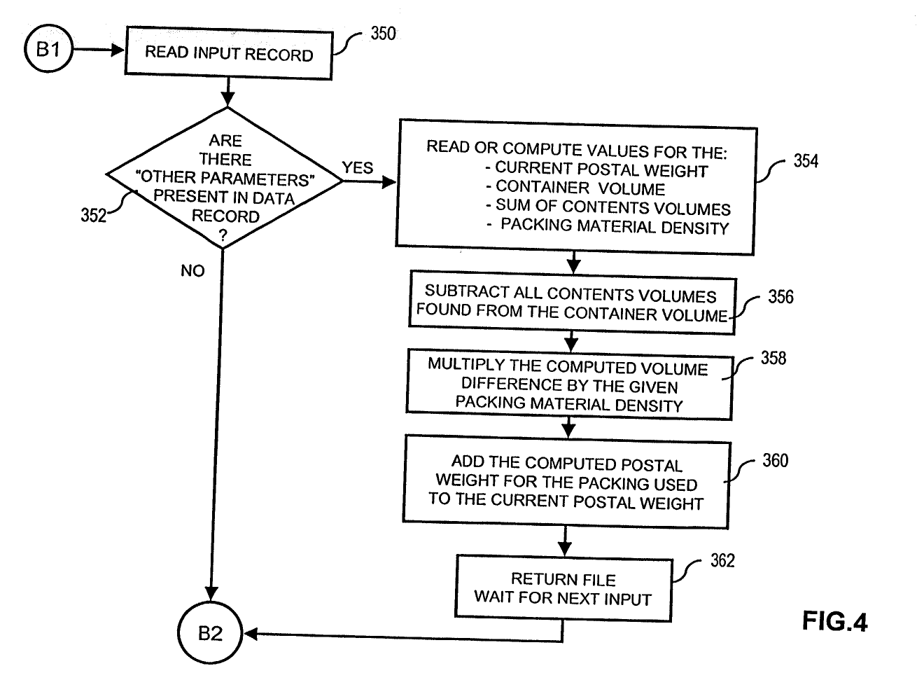

The query at step 206 asks if a UPC bar code is available for the parcel to be shipped. If the response to the query is “YES,” then the method advances to step 212 where the UPC value is compared to the UPC database to obtain an article postal or carrier weight, and the item volume and density, if found. Now the program goes to step 205 to buffer the current article weight with the other weight parameters and the current total weight. Then the program goes to decision block 203 to check if the total weight has been determined. If step 203 has not determined the total weight, the program goes to step 201 to read the next data field. If step 203 determines the total weight, the program goes to step 213 to determine if other parameters, i.e., density and volume, are present in the record. If step 213 determines no new parameters are present, the program goes to step 214. If step 213 determines that new parameters are present, the program goes to step 350 (FIG. 4). Once the weight is obtained, the method advances directly to step 214. However, if the response to the query at step 206 is “NO,” then the method advances to the query at step 208.

At step 208, the method queries at to whether the article can be identified by a description of the article. If the response to the query is “YES,” then the method advances to step 210 where the characteristics are input to the system, and the corresponding UPC data and the container weight are determined. From step 210, the method flow advances to step 205. If the response to the query at step 208 is “NO,” then the method advances along path A1 to step 230 as is shown in FIG. 2B.

Returning to step 214, the method applies the article data, including the weight obtained at step 252, to a rating engine to determine the rate to be charged for shipping the parcel via the selected carrier. The rate is returned at step 216 and applied to the article at step 218 by indicating the rate on a corresponding carrier manifest, producing a label (which generally lists the addressee as well) corresponding to the rate, or both. In step 219, the rate is applied for this container. The container is then prepared for shipping at step 220 and the routine for the parcel is concluded at step 222.

Turning to FIG. 2B, there is shown the steps for returning a weight from the weights database. The flow begins with an input at step 230 from path A1 coming from step 208 as is shown in FIG. 2A.

Step 230 is a query which asks if a manufacturer's name is present in the input data. If the response to the query is “YES,” then the method advances to step 232 where a search of the database by manufacturer name is conducted. The method then advances to step 234 which queries as to whether or not the manufacturer's name is available. If the response to the query at step 234 is “NO,” then the method advances to re-enter the flow at step 240. If however, the response to the query at step 234 is “YES,” then the method advances to the query at step 236 which asks if the manufacturer product number is available.

Returning to step 230, if the response to the query is “NO,” then the method advances to the query at step 240. At step 240, the system queries as to whether or not a product description is available. If the response to the query is “NO,” then the method advances to step 245. Step 245 requests that the user enter data the describes the product. Then the program advances to the query at step 246. If, however, the response to the query at step 240 is “YES,” then the program goes to step 242 to compare elements of the product description with elements in UPC database fields. Now the program advances to the query at step 244.

Returning to step 236, if the response to the query as to whether or not the product number is available is “NO,” then the method advances to step 242 where the elements of the product are compared with elements in the UPC database fields before advancing to the query at step 244. If the response to the query at step 236 is “YES,” then the system conducts a search of the database by the manufacturer's product number before advancing to the query at step 244.

At step 244, the system queries as to whether or not a match has been determined for the comparisons made of the manufacturer's name, product number, or description. If the response to the query is “NO,” then the program advances to step 245 where the user is requested to enter the data. Then the program goes to step 246. However, if the response to the query at step 244 is “YES,” then the method advances directly to step 252 and returns a weight to the cost/rating routine for use at step 214.

Turning to step 246, the method queries as to whether or not the system user can enter (e.g., via keyboard entry or scanner entry) the weight directly to the routine. If the response to the query is “YES,” then the data is entered into the entry fields of the routine at step 250; otherwise, if the response to the query is “NO,” then the program goes to step 247. Step 247 sends to the user's display the following message: “Weight is not available. Take finished package to post/carrier for cost/rating.” Then this routine goes to step 249 and then to step 222 to end. From step 250, the method advances to step 252 where the weight is returned to the application in step 216 (FIG. 2A) for use in determining the cost/rate.

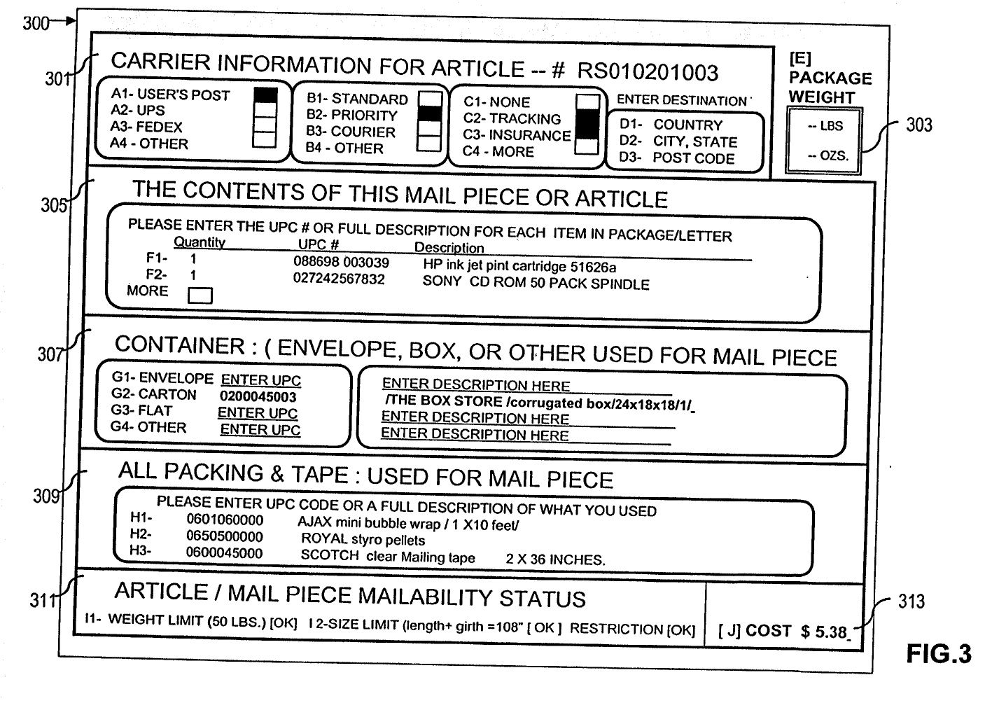

FIG. 3 is a drawing of a drawing of a view screen that will be displayed in the personal computer in user subsystem 10, user station 170, entry nodes 102, 104, 106, 108, and 110. The data entry screen 300 is made up of seven subscreens indicated as 301, 303, 305, 307, 309, 311, and 313. Each subscreen in turn contains one or more required data elements that the user must enter to define the article/mail piece for cost/rating, or to provide the needed data to allow computation of the container and its contents weight.

The first sub data entry screen 301 is in turn subdivided into four user data entry fields. They are identified as A, B, C, and D in 301. Each field allows the user to identify the chosen carrier (A), the level of delivery service requested (B), any other requested services (C), and finally the destination information (D) that enables delivery.

The next data entry subscreen 303 provides a field (E) where the user could enter the actual final accurate shipping weight when it is already known to them. These circumstances are likely found in a manufacturer parcel-shipping site where standard boxes, packing and contents are combined in known arrangements.

The next three subscreens (305, 307 and 309) provide the numeric and text information that enables the present invention to operate. Subscreen 305 contains data entry lines labeled F1, F2 and more. Each line has fields for both the UPC code assigned to the contents item, as printed on its label, or found in its description. The “F” lines are filled in with either the UPC or a description until all the items are accounted for. The next subscreen 307 deals with the mail piece container. At least one “G” line must be selected, and either the UPC number entered or the description. The next subscreen 309 deals with the packing and tape used to form the mail piece/container. At least one “H” line must be selected, and both the UPC number entered and a description of what was consumed.

Subscreens 311 and 313 are not for data entry. These subscreens inform the user about the status of the “mail-ability” in (“I”) of the mail piece, and the current cost in (J).

FIG. 4 is a flow chart of the process for determining the cost of the other materials used to complete the container. The program begins in step 350 when step 213 (FIG. 2A) detects other parameters.

Step 350 reads the input records from subscreens 310-309 (FIG. 3). Then the program goes to decision step 352. Step 352 determines whether or not other parameter data entries are present in the data record. If other parameters are not present, the program goes to step 214 (FIG. 2A). If other parameters are present in step 352, the program goes to step 354 to read or compute values for the current postal weight; container volume; sum of the contents items and packing material density. In step 356, the program subtracts all contents volumes found from the container volume. Then, in step 358 the program multiplies the computed volume difference by the given packing material density. In step 360, the program adds the computed postal weight for the packing used to the current postal weight. In step 362, the file is returned to step 214 (FIG. 2A)

FIG. 5 is a flow chart showing how the post or carrier detects weight/rating/cost/errors that are identified during normal article/mail piece acceptance processing. Prior to initiation of the corrective process, described in FIG. 5, a temporary article weight error file 371 is produced by a sortation process 370. Sortation process 370 out sorts all verified mail piece records that exceed post/carrier established acceptance value for a user-produced weighing error. The user-produced weighing error is usually 3-5% of the total weight.

The corrective processing starts at step 373 when the first record stored in step 371 is read in. Next, at step 375, the mail piece unique number that the system issued during the user cost/rating process, is read in from subscreen 301 data field (FIG. 3) and is retrieved from the archived user record 300.

Next the process moves to step 377 to establish if a user established “postal weight” was used. If this is the case (yes), the process moves to step 379 where it computes the value of the error, and then notifies the user and bills the user's account.

Next, at step 380, the process checks to see if there are any more records to process in step 371. If there are none to process, it moves to step 381 to clear the processed records in step 371 and then ends.

If there are additional files to process in step 371, the process gets the next record at step 392 and moves back to step 373. Returning to step 377, if a user supplied postal weight was not entered by the user, the process moves to step 383 where it verifies that the weights entered by the user interactive process matches the current UPC-based weights. If a mismatch is found, the process moves to step 379 where it follows the flow already discussed. If all the component weights are found to match those currently in the UPC database 54b (FIG. 1A), the process moves to step 385 to locate other mail pieces that contain the same item.

The process next moves to query the item manufacture's database over the Internet to verify the weight. It then moves to step 389 to produce a correction if needed. Then the process goes to step 390 to add the correction to a Weight Corrections database update file 391. Then the process moves to step 380. Then the system database 32 (FIG. 1A) is updated from time to time as needed using step 391.

In the foregoing specification, the invention has been described with reference to specific embodiments thereof. However, it will be evident that various modifications and changes may be made thereto without departing from the broader spirit and scope of the invention. The specification and drawings, accordingly, are to be regarded in an illustrative rather than a restrictive sense.

What is claimed is:

1. A method of providing for weight-based determinations of one or more articles to be shipped; the method comprising the steps of:
(a) initiating a cost determining routine in a shipping system application at a first node via the Internet;
(b) entering a code or a description of each one of said one or more articles into a first data field of said routine;
(c) transmitting a query from said routine based upon the code or description to a database containing product codes and/or descriptions for one or more articles, a product code or a description for packing material, and a product code or description for the container and the sealing material for the container that the one or more articles and the packing material that are going to be shipped located at a second node for a weight associated with said each one of said one or more articles, container packing materials and sealing materials;
(d) returning said weight to said cost routine for use in calculating a cost for shipping said each of said one or more articles, said packing material, and said container; and
(e) displaying the cost to ship the articles, container, packing material and sealing material.

2. The method of claim 1, wherein said first node is remote to said database.

25. A method of returning a weight from a weight field of a database wherein said database has at least one data field for storing a set of data relative to a corresponding article, packing material, and container, and wherein said set of data comprises at least said weight field, the method comprising the steps of:
(a) initiating a cost determining routine in a shipping system application at a first node;
(b) entering a description of said corresponding article, said packing material, and said container into a first data field of said rate determining routine;
(c) transmitting a query from said routine to said database for a weight associated with said corresponding article, said packing material, and said container;
(d) returning said weight to said routine; and
(e) displaying the cost to ship the article, packing material and container.

26. A system for determining the weight of an article, packing material, and container to be shipped, said system comprising:
(a) a data processing system located at a first node, said data processing system further comprising a shipping system application, said shipping system application further comprising cost determining means for determining a carrier cost to be charged for shipping of said article, said packing material, and said container;
(b) first data entry means for entering a product code of said article, a code of said packing material, and a product code of said container into a first data field of said shipping system application;
(c) transmission means for transmitting a query for a weight associated with said article, said packing material, and said container, from said shipping system application to a database located at a second node and then returning said weight to said application for use by said rate determining means;
(d) second data entry means for entering said weight into a second data field of said shipping system application as an input parameter; and
(e) calculating means within said cost determining means for calculating said cost for shipping said article, said packing material, and said container to said particular destination based upon a set of one or more input parameters.

40. A method of providing for weight-based determinations of one or more articles to be shipped, the method comprising the steps of:
a) initiating a cost determining routine in a shipping system application at a first node;
b) entering a code or a description of each one of said one or more articles into a first data field of said routine;
c) entering a code or a description of the container in which the articles are going to be shipped;
d) transmitting a query from said routine to a database located at a second node for a weight associated with said each one of said one or more articles and said container;
e) returning said weight to said routine for use in calculating a cost for shipping said each of said one or more articles and said container;
f) entering said weight into a second data field of said shipping system application as an input parameter; and
g) determining said cost for shipping said each of said one or more articles and container based upon a set of one or more input parameters.

41. The method of claim 40, wherein said initiation of said routine is via Internet or modem and where said initiating site is remote to said database.

42. The method of claim 40 wherein said initiation of said routine occurs at a data processing system co-located with said application and said database.

43. The method of claim 40, wherein said database further comprises a set of codes (such as UPC or EAN) data.

44. The method of claim 40, wherein said database further comprises a set of data comprising a recorded weight associated with a set of one or more articles wherein said recorded weight is entered by a system operator.

45. The method of claim 40, further including the steps of:
entering a code or a description of the packing material that is included in the container to be shipped; and
determining the cost for shipping the packing material.

46. The method claimed in claim 45, further including the steps of determining the weight of the packing material using the volume of the container minus the volumes of the articles in the container multiplied by the density of the packing material.

47. The method of claim 40, further including the steps of:
storing the cost for shipping each one or more articles and the container in a completed container data base at the second node;
submitting said container to a carrier for acceptance; and
determining by the carrier the cost to ship said container.

48. The method of claim 47, further including the step of:
isolating the containers that do not have the proper postage.

49. The method of claim 48, further including the step of:
billing mailers who have not paid sufficient funds to ship said container.

50. The method of claim 48, further including the step of:
refunding monies to mailers who have overpaid to ship said container.

51. The method claimed in claim 47, further including the steps of:
comparing the stored weight for shipping the article and container in the completed container database with the weight determined by the carrier to ship the container; and
querying the manufacturer of the articles and containers concerning their actual weight if the compared total weights are not the same.

52. The method claimed in claim 51, further including the step of:
updating the weights associated with each one or more articles and said container at the database located at the second node.
